(19) United States
(12) Patent Application Publication
(10) Pub. No.: US 2026/0328609 A1
(43) Pub. Date: Oct. 22, 2026

(54) LIQUID LEVEL MEASUREMENT SYSTEM USING LOCK-IN THERMOGRAPHY, AND METHOD THEREFOR

(71) Applicant: KOREA INSTITUTE OF MACHINERY & MATERIALS, Daejeon (KR)

(72) Inventors: Minchang KIM, Daejeon (KR); Byung Il CHOI, Daejeon (KR); Kyu Hyung DO, Daejeon (KR); Myung Bae KIM, Daejeon (KR); Yong Shik HAN, Daejeon (KR); Tae Hoon KIM, Daejeon (KR); Hwa Long YU, Busan (KR); Changhyun KIM, Daejeon (KR)

(21) Appl. No.: 19/108,788

(22) PCT Filed: Oct. 16, 2023
(86) PCT No.: PCT/KR2023/015930

§ 371 Date: Mar. 5, 2025

(30) Foreign Application Priority Data
Dec. 2, 2022 (KR) 10-2022-0167076

(51) Int. Cl. G01F 23/292; G01F 23/80; G01J 5/48

(52) U.S. Cl. CPC G01F 23/292; G01F 23/80; G01J 5/48

(57) ABSTRACT

The technology disclosed in the present specification relates to a liquid level measurement system, which is capable of efficient storage and transportation through identification of a boundary line of fluid in a storage tank, and a method therefor. The liquid level measurement system includes an infrared measurement unit configured to obtain a periodic response signal of a storage tank that receives a periodic signal from a light source, a calculation unit configured to determine a time lag value of a liquid by calculating a time lag value between the periodic signal and the periodic response signal, and a result output unit configured to measure a liquid level based on the determined time lag value.

### TECHNICAL FIELD

The technology disclosed in the present specification relates to a liquid level measurement system using lock-in thermography and a method therefor, and more particularly, to a liquid level measurement system, which is capable of efficient storage and transportation through identification of a boundary line of fluid in a storage tank, and a method therefor.

### BACKGROUND ART

A liquid level measurement device (level instrument) is a device installed inside and/or outside a storage tank or the like to measure an internal liquid level and is used to identify and control a liquid level of fluid so as to maintain the internal liquid level of the storage tank at a normal level. Here, there are a magnetic liquid level gauge, a displacement transmitter, a differential pressure transmitter, a radiographic transmitter, a glass liquid level gauge, a liquid level switch, and the like, which are applied to chemical facilities or auxiliary facilities of the chemical facilities by measuring signals thereof.

However, devices for measuring a liquid level in conventional storage and transportation devices are inconvenient to install and maintain. In case that the temperature or pressure of an environment in which the liquid level is measured changes, there is a limitation in that calibration has to be performed again so as to obtain a relationship between the measured signals and the liquid level value.

Accordingly, the applicant of the present application sought to study a simpler and more accurate liquid level measurement system by applying a principle of lock-in thermography to measuring liquid levels in storage and transportation devices.

### DISCLOSURE OF INVENTION

### Technical Problem

An exemplary objective of the present specification is to provide a system and method for measuring a liquid level by using lock-in thermography without additional calibration.

The technical objectives to be achieved by a liquid level measurement system using lock-in thermography and a method therefor according to the technical idea of the technology disclosed in the present specification are not limited to the objectives for solving the problems described above, and other objectives that are not described herein will be clearly understood from the following description by those of ordinary skill in the art.

### Solution to Problem

A liquid level measurement system using lock-in thermography according to an embodiment of the technology disclosed in the present specification includes an infrared measurement unit configured to obtain a periodic response signal according to a temperature distribution from a storage tank that receives a periodic signal of a light source, a calculation unit configured to determine a time lag value of a liquid by calculating a time lag value between the periodic signal and the periodic response signal, and a result output unit configured to measure a liquid level based on the determined time lag value.

### Advantageous Effects of Invention

A liquid level measurement system using lock-in thermography and a method therefor according to the present disclosure have an effect of easily and accurately measuring a liquid level of a storage tank.

In addition, the liquid level measurement system using lock-in thermography and the method therefor according to the present disclosure have an effect of enabling simple and efficient storage and transportation because no additional calibration is required.

However, the effects according to an embodiment of the technology disclosed in the present specification are not limited to those described above, and other effects that are not described herein will be clearly understood from the following description by those of ordinary skill in the art.

### BRIEF DESCRIPTION OF DRAWINGS

FIG. 1 briefly illustrates a principle of lock-in thermography according to the technical idea of the present disclosure.

FIG. 2 briefly illustrates a liquid level measurement system using lock-in thermography according to an embodiment of the technical idea of the present disclosure.

FIG. 3 illustrates a time lag value in a storage tank according to an embodiment of the technical idea of the present disclosure.

FIG. 4 illustrates a time lag distribution chart displayed on a result output unit according to an embodiment of the technical idea of the present disclosure.

### BEST MODE FOR CARRYING OUT THE INVENTION

A liquid level measurement system using lock-in thermography according to an embodiment of the technology disclosed in the present specification includes an infrared measurement unit configured to obtain a periodic response signal according to a temperature distribution from a storage tank that receives a periodic signal of a light source, a calculation unit configured to determine a time lag value of a liquid by calculating a time lag value between the periodic signal and the periodic response signal, and a result output unit configured to measure a liquid level based on the determined time lag value.

In the liquid level measurement system using lock-in thermography according to an embodiment of the technology disclosed in the present specification, a coating layer having a constant emissivity is applied onto at least one surface of the storage tank.

In the liquid level measurement system using lock-in thermography according to an embodiment of the technology disclosed in the present specification, the coating layer includes a thermal tape.

In the liquid level measurement system using lock-in thermography according to an embodiment of the technology disclosed in the present specification, the light source is configured to emit a periodic signal to the applied coating layer.

In the liquid level measurement system using lock-in thermography according to an embodiment of the technology disclosed in the present specification, the light source has a constant period and amplitude due to an alternating current power supply.

In the liquid level measurement system using lock-in thermography according to an embodiment of the technology disclosed in the present specification, the calculation unit uses a first peak point of each of the signals.

In the liquid level measurement system using lock-in thermography according to an embodiment of the technology disclosed in the present specification, the calculation unit is configured to calculate a time lag value by dividing a distribution of the periodic response signal received from the infrared measurement unit into a plurality of pixel points.

In the liquid level measurement system using lock-in thermography according to an embodiment of the technology disclosed in the present specification, the calculation unit is configured to determine a pixel point at which the time lag value changes rapidly.

In the liquid level measurement system using lock-in thermography according to an embodiment of the technology disclosed in the present specification, the result output unit is configured to measure a liquid level by multiplying a number of pixels between the determined pixel point and a lowermost pixel point by a pixel size.

A liquid level measurement method using lock-in thermography according to an embodiment of the technology disclosed in the present specification includes storing a fluid in a storage tank, emitting a periodic signal to one surface of the storage tank from a light source having a constant period and amplitude, receiving, by an infrared measurement device, a periodic response signal for each temperature distribution from the storage tank, determining a time lag value of the fluid by calculating a time lag value between the periodic signal and the periodic response signal, and measuring a liquid level based on the determined time lag value.

In the liquid level measurement method using lock-in thermography according to an embodiment of the technology disclosed in the present specification, a coating layer having a constant emissivity is applied onto at least one surface of the storage tank.

In the liquid level measurement method using lock-in thermography according to an embodiment of the technology disclosed in the present specification, the emitting of the periodic signal includes emitting the periodic signal to the coating layer having a constant emissivity and applied onto the at least one surface of the storage tank.

In the liquid level measurement method using lock-in thermography according to an embodiment of the technology disclosed in the present specification, the receiving of the periodic response signal includes obtaining a temperature distribution chart for each pixel dividing one surface of the storage tank.

In the liquid level measurement method using lock-in thermography according to an embodiment of the technology disclosed in the present specification, the determining of the time lag value of the fluid includes determining a pixel point at which the calculated time lag value changes rapidly by substituting the obtained temperature distribution chart with a time lag distribution chart.

In the liquid level measurement method using lock-in thermography according to an embodiment of the technology disclosed in the present specification, the measuring of the liquid level includes measuring the liquid level by multiplying a number of pixels between the determined pixel point and a lowermost pixel point by a pixel size.

A computer program stored on a non-transitory recording medium and including instructions according to an embodiment of the technology disclosed in the present specification is configured to perform the method described above.

### MODE FOR THE INVENTION

As the technology disclosed in the present specification allows for various changes and numerous embodiments, particular embodiments will be illustrated in the drawings and described in detail in the detailed description. However, this is not intended to limit the technology disclosed in the present specification to specific embodiments, and it should be understood that the technology disclosed in the present specification includes all modifications, equivalents, and substitutes falling within the spirit and scope of the technology disclosed in the present specification.

In describing the technology disclosed in the present specification, when the detailed description of the relevant known technology is determined to unnecessarily obscure the gist of the technology disclosed in the present specification, the detailed description thereof is omitted. Also, numbers (for example, first, second, or the like) used in the description of the present specification are merely identification symbols for distinguishing one element from another.

Also, when an element is referred to as being “connected” or “coupled” to another element, the element may be directly connected or coupled to the other element, but it will be understood that the elements may be connected or coupled to each other via an intervening element therebetween unless otherwise stated.

Also, an element represented by “unit” in the present specification may be one element in which two or more elements are combined, or may be divided into two or more element for each more subdivided function. Also, each of the elements to be described below may additionally perform, in addition to the main function thereof, some or all of the functions that other elements are responsible for, and some of the main functions that the respective elements are responsible for may be dedicated by other elements.

The expressions “first,” “second,” or the like used in various embodiments may modify various elements, regardless of the order and/or importance, and do not limit the elements. For example, while not departing from the scope of the technology disclosed in the present specification, a first element may be referred to as a second element, and similarly, a second element may be referred to as a first element.

Hereinafter, a liquid level measurement system using lock-in thermography and a method therefor according to a preferred embodiment is described in detail.

First, lock-in thermography is a non-destructive, non-contact detection technique for detecting defects in electronic components or the like. By synchronizing a signal that activates a defect in a component or the like with an infrared camera at the same frequency, an amplitude image or a phase image for a position and characteristic of the defect is generated. By utilizing such a lock-in detection, the sensitivity of thermography which indicates the amount, change, or distribution of heat may be greatly improved.

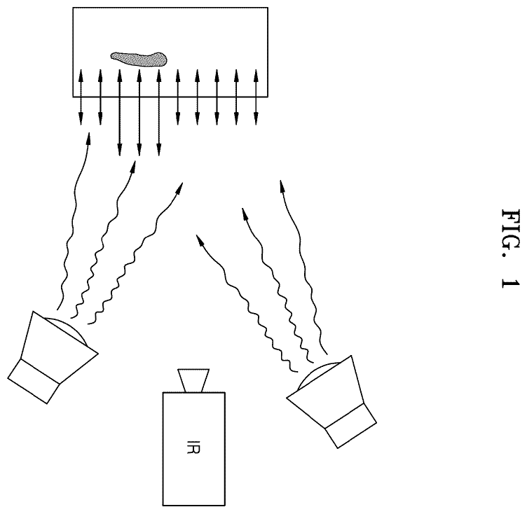

FIG. 1 briefly illustrates a principle of lock-in thermography according to the technical idea of the present disclosure.

The principle of lock-in thermography according to the technical idea of the present disclosure is to apply a principle that a change in temperature induced from the outside on a surface of an inspected component is propagated as a heat wave. As illustrated in FIG. 1, the principle of lock-in thermography is a mechanism for emitting a periodic energy signal to an inspection target, measuring a response signal by using an infrared camera, and then measuring a time lag between the two signals. In this case, in case that a defect exists in the inspection target, a different time lag value is measured only in a defective site. Such a principle may be used to identify the sizes, positions, or the like of internal defects in the inspection target or the like.

Hereinafter, a liquid level measurement system using the above-described principle and a method therefor are described.

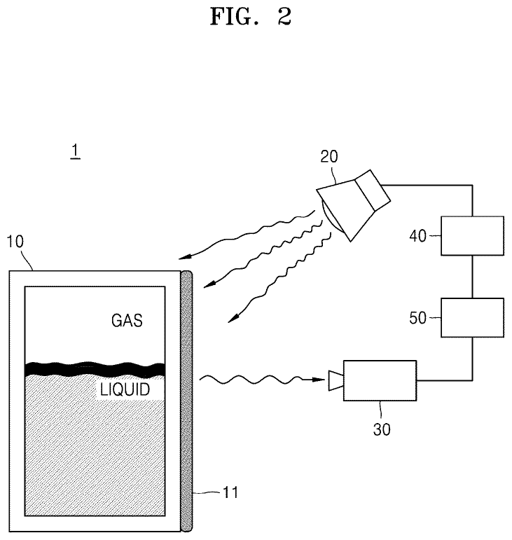

FIG. 2 briefly illustrates a liquid level measurement system using lock-in thermography according to an embodiment of the technical idea of the present disclosure.

A liquid level measurement system 1 using lock-in thermography according to an embodiment of the technology disclosed in the present specification may include an infrared measurement unit 30, a calculation unit 40, and a result output unit 50.

The infrared measurement unit 30 may be configured to obtain a periodic response signal from a storage tank 10 that receives a periodic signal emitted from a light source 20. The storage tank 10 may be configured to store and transport a fluid, such as a cryogenic fluid.

A coating layer having a constant emissivity may be applied onto at least one surface of the storage tank 10. When the surface of the coating layer is uniform and the emissivity of the coating layer is 1, the positions of the light source 20 and the infrared measurement unit 30 may not affect a time lag value. In addition, even in case that the emissivity is less than 1, the time lag value may be less than a difference in time lag value between a liquid region and a gas region, even when the time lag value is different according to the positions of the light source 20 and the infrared measurement unit 30.

The coating layer of the storage tank 10 may be applied onto the entire height of one surface of the storage tank to be measured, and the horizontal width of the coating layer may be configured to accommodate about 10 or more pixels measured by the infrared camera. However, in case that the position of the infrared camera is fixed, the horizontal width of the required coating may be narrower as the number of pixels in the infrared camera increases.

In addition, the coating layer of the storage tank 10 may include a black spray paint or a tape. The tape is a thermal tape used for heat transfer and may have an emissivity of 0.8 or more. This may usually include an aluminum material and may include an adhesive layer and a polymer coating layer for high emissivity.

The light source 20 may be a halogen lamp and may emit a periodic signal toward the coated surface of the storage tank 10. This may vary power supplied to the halogen lamp by using an alternating current power supply, so that the power has a constant period and a constant amplitude. In addition, the alternating current power supply may be connected to a computer so as to be configured to receive the magnitude and time value of the periodic signal, which is an alternating current power supply signal, through the computer.

Similarly, the infrared measurement unit 30 may be connected to the computer to obtain periodic temperature signals from every pixel in the infrared camera.

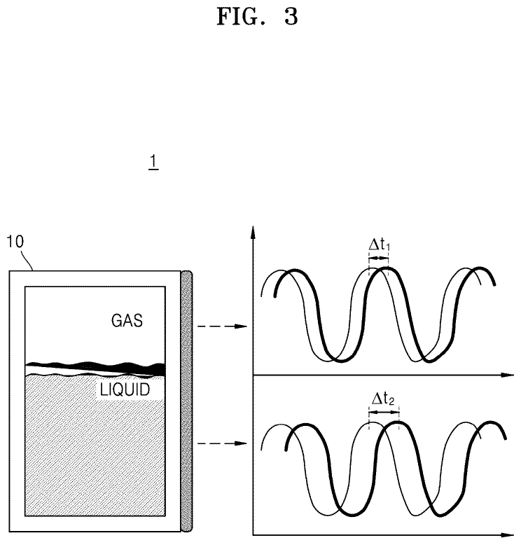

FIG. 3 illustrates the time lag value in the storage tank according to an embodiment of the technical idea of the present disclosure.

The calculation unit 40 may be configured to determine the time lag value of the liquid by calculating the time lag value between the emitted periodic signal and the received periodic response signal. A difference between a time value of a peak point of the received temperature graph for each pixel and a time value of a peak point of the alternating current power supply signal may be calculated and obtained. As illustrated in FIG. 3, the difference in time value may use the first peak point of each signal.

The result output unit 50 may be configured to measure the liquid level based on the determined time lag value. According to the principle of lock-in thermography described above, it may be confirmed that the time lag value in the region occupied by liquid in the storage tank 10 is different from the time lag value in the region occupied by gas in the storage tank 10, and it may be configured to determine pixels in which the time lag value changes rapidly.

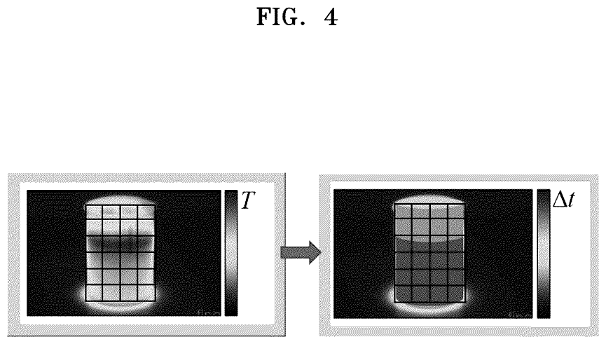

FIG. 4 illustrates the time lag distribution chart displayed on the result output unit according to an embodiment of the technical idea of the present disclosure.

The result output unit 50 may calculate the height occupied by the liquid in the storage tank 10, that is, the liquid level by calculating the number of pixels between a pixel point determined by the above-described principle and a pixel point located at the lowermost point of the storage tank 10 and multiply the number by a determined pixel size.

Pixel values having non-constant time lag values and singular points may be generated in a temperature signal measured in a critical section of liquid and gas, but this may be corrected by an interface. In addition, regions other than the inside of the storage tank 10 may have little temperature response according to the light source, and thus, the time lag values may not be calculated.

As another embodiment of the technical idea disclosed in the present specification, a liquid level measurement method using lock-in thermography may be provided.

The liquid level measurement method using lock-in thermography may include emitting a periodic signal from a light source having a constant period and amplitude to one surface of the storage tank while a fluid is stored in the storage tank 10, receiving, by an infrared measurement device, a periodic response signal emitted from the storage tank, calculating a time lag value between the periodic signal and the periodic response signal, determining a time lag value of the fluid, and measuring a liquid level based on the determined time lag value.

To effectively control the methods described above, the present disclosure may further include a computer program including instructions for performing the method. The computer program is stored in a data storage medium, and the instructions for performing the methods described above are read by a processor of a computer according to values input by a user or a set environment.

The method described above and the control therefor may be implemented as a hardware component, a software component, and/or a combination of a hardware component and a software component. For example, the methods and components described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing instructions and responding to instructions. A processing device may execute an operating system (OS) and one or more software applications running on the OS. In addition, the processing device may access, store, manipulate, process, and generate data in response to the execution of the software. For ease of understanding, the processing device is sometimes described as being used alone, but it may be understood by those of ordinary skill in the art that the processing device includes a plurality of processing elements and/or a plurality of types of processing elements. For example, the processing device may include a plurality of processors or one processor and one controller. In addition, other processing configurations, such as parallel processors, are also possible.

The software may include a computer program, code, instructions, or a combination of one or more thereof, and may configure a processing device to operate as desired or may instruct the processing device independently or collectively. The software and/or data may be permanently or temporarily embodied in any type of machine, component, physical device, virtual device, computer storage medium, or device so as to be interpreted by the processing device or to provide instructions or data to the processing device. The software may be distributed across network-connected computer systems and stored or executed in a distributed manner. The software and data may be stored on one or more computer-readable recording media.

The method according to an embodiment may be implemented in the form of program instructions that are executable through a variety of computer means and may be recorded on a computer-readable medium. The computer-readable medium may include program instructions, data files, data structures, or the like alone or in combination. The program instructions recorded on the medium may be specially designed and configured for the embodiment or may be known and available to those of ordinary skill in the art of computer software. Examples of the computer-readable recording medium may include magnetic media, such as hard disk, floppy disk, and magnetic tape, optical media, such as compact disc read-only memory (CD-ROM) and digital versatile disc (DVD), magneto-optical media, such as floptical disk, and hardware devices specially configured to store and execute program instructions, such as read-only memory (ROM), random access memory (RAM), and flash memory. Examples of the program instructions may include not only machine language code generated by a compiler but also high-level language code that is executable using an interpreter by a computer. The hardware devices described above may be configured to operate as one or more software modules so as to perform the operations of the embodiment, and vice versa.

As described above, although the embodiments have been described with reference to the restrictive embodiments and drawings, various modifications and variations may be made thereto from the above description by those of ordinary skill in the art. For example, appropriate results may be achieved even when the technologies described above are performed in an order different from the methods described above, and/or components of the system, structure, device, and circuit described above are coupled or combined in a different form from the methods described above or are replaced or substituted by other components or equivalents.

Therefore, other implementations, other embodiments, and equivalents to the claims also fall within the scope of the claims described below.

1. A liquid level measurement system using lock-in thermography, the liquid level measurement system comprising:
an infrared measurement unit configured to obtain a periodic response signal according to a temperature distribution from a storage tank that receives a periodic signal of a light source;
a calculation unit configured to determine a time lag value of a liquid by calculating a time lag value between the periodic signal and the periodic response signal; and
a result output unit configured to measure a liquid level based on the determined time lag value.

2. The liquid level measurement system of claim 1, wherein at least one surface of the storage tank comprises a coating layer having a constant emissivity.

3. The liquid level measurement system of claim 2, wherein the coating layer comprises a thermal tape.

4. The liquid level measurement system of claim 1, wherein the light source has a constant period and amplitude due to an alternating current power supply.

5. The liquid level measurement system of claim 1, wherein the calculation unit is configured to calculate the time lag value by using a first peak point of each of the periodic signal and the periodic response signal.

6. The liquid level measurement system of claim 1, wherein the calculation unit is configured to calculate a time lag value for each of a plurality of pixel points of the temperature distribution measured by the infrared measurement unit.

7. The liquid level measurement system of claim 6, wherein the calculation unit is configured to determine a pixel point at which the time lag value changes rapidly.

8. The liquid level measurement system of claim 7, wherein the result output unit is configured to measure a liquid level by multiplying a number of pixels between the determined pixel point and a lowermost pixel point by a pixel size.

9. A liquid level measurement method using lock-in thermography, the liquid level measurement method comprising:
storing a fluid in a storage tank;
emitting a periodic signal to one surface of the storage tank from a light source having a constant period and amplitude;
receiving, by an infrared measurement device, a periodic response signal for each temperature distribution from the storage tank;
determining a time lag value of the fluid by calculating a time lag value between the periodic signal and the periodic response signal; and
measuring a liquid level based on the determined time lag value.

10. The liquid level measurement method of claim 9, wherein a coating layer having a constant emissivity is applied onto at least one surface of the storage tank.

11. The liquid level measurement method of claim 9, wherein the emitting of the periodic signal comprises emitting the periodic signal to the coating layer having a constant emissivity and applied onto the at least one surface of the storage tank.

12. The liquid level measurement method of claim 9, wherein the receiving of the periodic response signal comprises calculating a time lag value for each of a plurality of pixel points of the temperature distribution measured by the infrared measurement device.

13. The liquid level measurement method of claim 12, wherein the determining of the time lag value of the fluid comprises determining a pixel point at which the calculated time lag value changes rapidly.

14. The liquid level measurement method of claim 9, wherein the measuring of the liquid level comprises measuring the liquid level by multiplying a number of pixels between a determined pixel point and a lowermost pixel point by a pixel size.

15. A computer program stored on a non-transitory recording medium and comprising instructions, wherein the instructions are configured to perform a liquid level measurement method using lock-in thermography, the liquid level measurement method comprising:
storing a fluid in a storage tank;
emitting a periodic signal to one surface of the storage tank from a light source having a constant period and amplitude:
receiving, by an infrared measurement device, a periodic response signal for each temperature distribution from the storage tank;
determining a time lag value of the fluid by calculating a time lag value between the periodic signal and the periodic response signal; and
measuring a liquid level based on the determined time lag value.

16. The computer program of claim 15, wherein a coating layer having a constant emissivity is applied onto at least one surface of the storage tank.

17. The computer program of claim 15, wherein the emitting of the periodic signal comprises emitting the periodic signal to the coating layer having a constant emissivity and applied onto the at least one surface of the storage tank.

18. The computer program of claim 15, wherein the receiving of the periodic response signal comprises calculating a time lag value for each of a plurality of pixel points of the temperature distribution measured by the infrared measurement device.

19. The computer program of claim 18, wherein the determining of the time lag value of the fluid comprises determining a pixel point at which the calculated time lag value changes rapidly.

20. The computer program of claim 15, wherein the measuring of the liquid level comprises measuring the liquid level by multiplying a number of pixels between a determined pixel point and a lowermost pixel point by a pixel size.
